(19) United States
(12) Patent Application Publication
(10) Pub. No.: US 2025/0100342 A1
(43) Pub. Date: Mar. 27, 2025

(54) VEHICLE HEATING DEVICE

(71) Applicant: Hanon Systems, Daejeon (KR)

(72) Inventor: Dong Hoon OH, Daejeon (KR)

(21) Appl. No.: 18/727,932

(22) PCT Filed: Mar. 21, 2023
(86) PCT No.: PCT/KR2023/003688

§ 371 Date: Jul. 10, 2024

(30) Foreign Application Priority Data
Apr. 13, 2022 (KR) 10-2022-0045782

(51) Int. Cl. B60H 1/00; B60H 1/22

(52) U.S. Cl. CPC B60H 1/00664; B60H 1/00021; B60H 1/2225; B60H 1/2226; B60H 2001/00092

(57) ABSTRACT

An embodiment discloses a vehicle heating device connected to an air conditioning unit to radiate heat, including a housing connected to the air conditioning unit, a heating module arranged inside the housing, and a cover coupled to the housing, wherein the cover comprises a cover body and guides configured to direct air passing through the cover body, the guides having a predetermined separation distance from the heating module. Accordingly, the vehicle heating device can enhance the heating performance, efficiency, and quality of the vehicle interior through convection or radiant heating using the heating unit.

### TECHNICAL FIELD

The embodiments relate to a vehicle heating device. More particularly, this relates to a vehicle heating device that heats the interior of a vehicle through convection or radiation.

### BACKGROUND ART

A vehicle is equipped with an air conditioning device for a vehicle that serves to adjust an air temperature or the like in a vehicle interior. The air conditioning device may produce warm air to keep the interior of the vehicle warm in the winter season or produce cold air to keep the interior of the vehicle cool in the summer season.

The air conditioning device may include an air conditioning unit configured to supply air with an adjusted temperature to the vehicle interior, and a blower unit configured to supply air to the air conditioning unit.

The air conditioning unit may include: an air-conditioning casing having a plurality of discharge ducts; an evaporator disposed in the air-conditioning casing; a heater; and a door configured to adjust an air flow rate. Therefore, the air conditioning unit may adjust a temperature of the air, which is to be supplied to the interior of the vehicle, by using the evaporator, the heater, and the door. In this case, the heater may be a positive temperature coefficient (PTC) heater using a PTC element.

Further, the blower unit may supply air into the air conditioning unit by using a blower rotated by an actuator (not illustrated).

Meanwhile, the air conditioning device may use an infrared lamp to perform local heating and air-conditioning.

As the invention related to the infrared lamp, there is Korean Patent Laid-Open No. 10-2018-0055961 (May 28, 2018) entitled ‘Infrared Ray Heater for Vehicle’.

FIG. 1 is a view illustrating an infrared heater for a vehicle in the related art.

Referring to FIG. 1, the infrared heater may locally heat an interior of the vehicle by using an infrared lamp 1400.

In this case, the infrared heater may include: heat radiating fins 1201 disposed in an air conditioning duct 1200; reflective plates 1101 configured to reflect heat radiated from the infrared lamp 1400; and heat transfer parts 1103 configured to thermally connect the reflective plates 1101 and the heat radiating fins 1201. Further, the infrared heater may further include barrier films 1303 configured to cover an opening of the reflective plate 1101.

Because the infrared heater uses the infrared lamp 1400, the infrared heater needs to have the reflective plate 1101 and essentially have the heat transfer parts 1103 and the heat radiating fins 1201 to transfer heat to the air-conditioning duct 1200.

However, the configuration including the reflective plate 1101, the heat transfer parts 1103, and the heat radiating fins 1201 increases the size of the infrared heater. Therefore, because the infrared heater with the increased size needs to occupy a part of an interior space of the vehicle, the interior space is reduced, which limits a degree of design freedom of the vehicle.

In addition, continuous operation of the infrared lamp 1400 may lead to overheating. This overheating can cause damage to the vehicle.

Moreover, the infrared heater may cause safety problems due to the lack of safety devices for occupant access.

### DISCLOSURE

### Technical Problem

The embodiments provide a vehicle heating device that heats the interior of a vehicle through convection or radiation.

The embodiments provide a heating module including a structurally and electrically overheating-proof heating unit, and a vehicle heating device including the heating module.

The embodiments provide a vehicle heating device with safety devices to ensure the safety of the occupants.

Objectives to be solved by embodiments are not limited to the objectives described above, and objectives which are not described above will be clearly understood by those skilled in the art from the following descriptions.

### Technical Solution

The above objects are accomplished by a vehicle heating device connected to an air conditioning unit to radiate heat, including a housing connected to the air conditioning unit, a heating module arranged inside the housing, and a cover coupled to the housing, wherein the cover includes a cover body and guides configured to direct air passing through the cover body, the guides having a predetermined separation distance from the heating module.

Here, the guides may include a first guide and a second guide, the second guide being arranged at a predetermined inclination angle relative to the first guide.

In addition, the heating module may include a heating unit and a frame configured to support the heating unit,
wherein the heating unit may include a planar body with a hole formed therein, a first electrode and a second electrode arranged on the body, and a heating element arranged between the first and second electrodes, and the separation distance may be equal to or smaller than the shortest width (W) of the hole.

Preferably, the second separation distance D2 may be formed within the range of 0.5 to 0.75 times the shortest width W of the holes 211.

In addition, the shortest width (W) of the hole may be formed to be larger than the shortest width of a guide hole formed in the cover body.

Meanwhile, the cover may further include a ventilation hole formed on a side of the cover body.

In addition, the housing is rotatably connected to a floor duct of the air conditioning unit.

In addition, the heating element may include a first heating element and a second heating element different rates of change in electrical resistance at a predetermined temperature, and the first heating element and the second heating element may be connected in series between the first electrode and the second electrode.

Here, the second heating element may have a non-linear rate of increase in resistance with temperature at a predetermined temperature.

In addition, the first heating element may have a smaller rate of change in resistance with temperature compared to the second heating element at a predetermined temperature.

In addition, the first electrode, the second electrode, the first heating element, and the second heating element may be disposed on the body by a printing method.

In addition, the heating unit may further include a cover member arranged to cover the first electrode, the second electrode, the first heating element, and the second heating element.

Meanwhile, the frame may include an upper plate with a plurality of holes formed therein, and a lower plate arranged spaced apart from the upper plate and having a plurality of holes formed therein, wherein the heating unit may include an upper heating unit disposed on the upper plate and a lower heating unit disposed on the lower plate.

Here, a heat exchange area may be formed between the upper plate and the lower plate, and air passing through the plurality of holes formed in the upper heating unit respectively may mix in the heat exchange area, exchanging heat with radiant heat from the upper and lower heating units.

In addition, the holes formed in the upper plate may be arranged to overlap with the holes formed in the lower plate.

In addition, the first heating element arranged on the upper heating unit may be positioned to overlap with the holes formed in the lower heating unit, based on the direction of airflow.

In addition, the heating unit may include an upper heating unit and a low heating unit to which power is selectively applied to perform heating through at least one of convective heat generated by heating the air passing through the holes and radiant heat directly emitted towards the occupants.

Meanwhile, the vehicle heating device may further include a sensor configured to detect objects approaching the heating module.

In addition, the frame may be formed of a metal material, and the body may be formed of a synthetic resin material.

### Advantageous Effects

According to the embodiments, the vehicle heating device is advantageous in terms of heating the interior of a vehicle through convection or radiation in connection with the air conditioning unit. The vehicle heating device is advantageous in terms of improving heating performance and quality for the occupants by quickly heating the interior of the vehicle in such a way as to heating the air supplied by the air conditioning unit or directly heating the occupants using radiant heat. That is, the vehicle heating device is advantageous in terms of further improving heating performance and quality by providing selective control over convection and radiant heating.

The vehicle heating device is also advantageous in terms of preventing overheating of the heating module and the vehicle heating device, which includes the heating module, by employing an electrical structure capable of preventing overheating of the heating unit that emits heat.

The vehicle heating device is also advantageous in terms of improving safety by using safety mechanisms. In detail, the use of a cover is capable of prevent direct contact between occupants and the heating unit. The vehicle heating device is also advantageous in terms of ensuring occupant safety by controlling the operation of the heating unit using a sensor that detects when a part of an occupant's body approaches within a predetermined distance.

Various useful advantages and effects of the embodiments are not limited to the above-described contents and will be more easily understood from descriptions of the specific embodiments.

### DESCRIPTION OF DRAWINGS

FIG. 1 is a diagram illustrating a conventional vehicle infrared heater;

FIG. 2 is a diagram illustrating the air flow in a vehicle air conditioning system and a vehicle heating device according to an embodiment;

FIG. 3 is a perspective view illustrating a vehicle air conditioning system and a vehicle heating device according to an embodiment;

FIG. 4 is a cross-sectional view illustrating a vehicle air conditioning system and a vehicle heating device according to an embodiment;

FIG. 5A is a diagram illustrating a vehicle heating device heating around the ankles of an occupant according to an embodiment;

FIG. 5B is a diagram illustrating a vehicle heating device heating around the calves of an occupant according to an embodiment;

FIG. 6 is an exploded perspective view illustrating a vehicle heating device according to an embodiment;

FIG. 7 is a diagram illustrating the arrangement relationship between a heating module and a support member in a vehicle heating device according to an embodiment;

FIG. 8 is an exploded perspective view illustrating a heating module of a vehicle heating device according to an embodiment;

FIG. 9 is a diagram illustrating a planar heating unit arranged in a heating module of a vehicle heating device according to an embodiment;

FIG. 10 is a diagram illustrating a variant of the planar heating unit arranged in a heating module of a vehicle heating device according to an embodiment;

FIG. 11 depicts graphs illustrating the relationship between resistance and temperature for a first heating element arranged in a heating unit of a vehicle heating device according to an embodiment;

FIG. 12 depicts a graph illustrating the relationship between resistance and temperature for a second heating element arranged in a heating unit of a vehicle heating device according to an embodiment;

FIG. 13 is a diagram illustrating the manufacturing process of a heating unit of a vehicle heating device according to an embodiment;

FIG. 14 is a cross-sectional view illustrating a frame of a vehicle heating device according to an embodiment;

FIG. 15 is a cross-sectional view illustrating a frame of a vehicle heating device according to another embodiment;

FIG. 16 is a diagram illustrating the airflow through a heating module with a housing and a frame arranged in the vehicle heating device according to an embodiment;

FIG. 17 is a diagram the heat exchange through a heating module with a housing and a frame arranged in the vehicle heating device according to an embodiment;

FIG. 18 is a perspective view illustrating a cover of a vehicle heating device according to an embodiment;

FIG. 19 is a plan view illustrating a cover of a vehicle heating device according to an embodiment;

FIG. 20 is a cross-sectional view illustrating a cover of a vehicle heating device according to an embodiment;

FIG. 21 is a cross-sectional view illustrating a vehicle heating device with a cover according to another embodiment;

FIG. 22 is a diagram illustrating the air flow in a vehicle heating device with a cover according to another embodiment;

FIG. 23 is a diagram illustrating a guide arranged close to a heating module of a vehicle heating device according to an embodiment;

FIG. 24 is a diagram illustrating a guide arranged to maintain a predetermined distance from a heating module of a vehicle heating device according to an embodiment;

FIG. 25 is a diagram illustrating a vent hole formed on a cover of a vehicle heating device according to an embodiment;

FIG. 26 is a diagram illustrating a sensor of a vehicle heating device according to an embodiment; and

FIGS. 27 to 29 are diagrams illustrating the operation control of a vehicle heating device according to an embodiment.

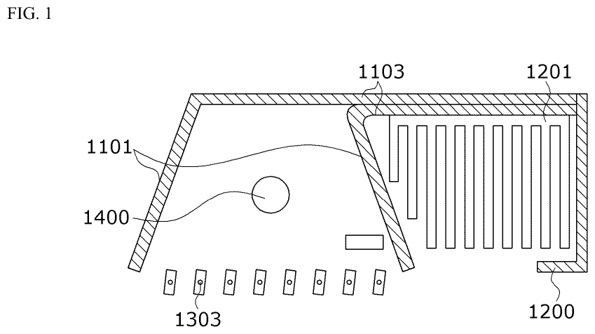

### MODE FOR INVENTION

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used herein to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination among a plurality of associated listed items.

When an element is referred to as being “connected” or “coupled” to another element, it will be understood that the element can be directly connected or coupled to another element, or other elements may be present therebetween. In contrast, when an element is referred to as being “directly connected” or “directly coupled” to another element, it will be understood that there are no intervening elements.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The terminology used herein is for the purpose of describing particular embodiments only and is not intended to limit the present invention. The singular forms are intended to include the plural forms, unless the context clearly indicates otherwise. In the present specification, it should be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

Hereinafter, when embodiments are described in detail with reference to the accompanying drawings, components that are the same or correspond to each other will be denoted by the same or corresponding reference numerals in all drawings, and redundant descriptions will be omitted.

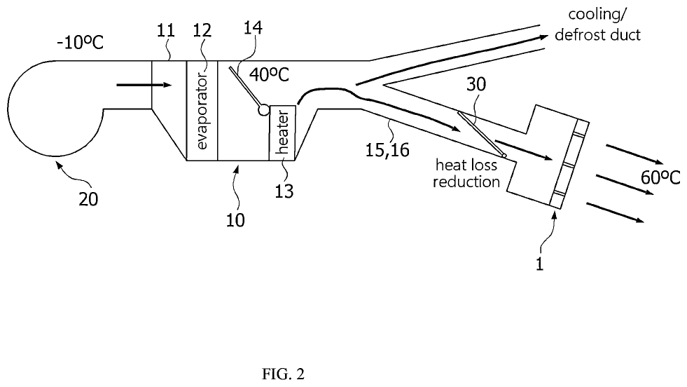

FIG. 2 is a diagram illustrating the air flow in a vehicle air conditioning system and a vehicle heating device according to an embodiment.

With reference to FIG. 2, the vehicle heating device 1 according to an embodiment is connected to one side of the air conditioning system that supplies air to the vehicle interior, allowing heating of the vehicle interior through at least one of convection and radiation. Here, the air conditioning system may include an air conditioning unit 10 and a blower unit 20. The vehicle heating device 1 may be connected to one side of the air conditioning unit 10.

The blower unit 20 may supply air to the interior of the air conditioning unit 10 using a blower (not shown) that rotates by an actuator (not shown). The air conditioning unit 10 may include a cooling heat exchanger, such as an evaporator 12, and a heating heat exchanger, such as a heater 13, that are installed inside. Accordingly, the temperature of the air passing through the air conditioning unit 10 may be adjusted. Here, the heater 13 may be a positive temperature coefficient (PTC) heater that utilizes a PTC element.

The vehicle heating device 1 may be provided as a single unit heating module, and this heating module may be arranged on the airflow path connected to the air conditioning unit 10 to emit heat towards the occupants. For example, the vehicle heating device 1 may be positioned on one side of the air conditioning case 11 of the air conditioning unit 10. In detail, the vehicle heating device 1 may be arranged to be to one of a plurality of outlet ducts located on one side of the air conditioning case 11, such as the floor duct 15 or console duct 16, and may heat the air flowing through the floor duct 15 or the console duct 16. Here, the floor duct 15 or the console duct 16 may be provided as part of the airflow path connected to the air conditioning case 11. Therefore, the air supplied to the air conditioning unit 10 and passing through the heat exchanger may move to the heating module through the path. Here, the heating module may encompass various electric heaters such as PTC heaters with holes, film heaters, and surface heating heaters. However, considering the degree of design freedom and manufacturing process of the vehicle heating device 1, the film heater is advantageous.

Accordingly, despite the heater 13 inside the air conditioning case 11 heating the air to around 40 degrees, the vehicle heating device 1 connected to the end of the floor duct 15 or the console duct 16 compensates for the air temperature, thereby minimizing heat loss through the floor duct 15 or the console duct 16. For example, in the conventional case where the vehicle heating device 1 is not installed in the floor duct 15 or the console duct 16, the heater 13 inside the air conditioning case 11 heated the air to over 60 degrees and supplied the heated air to the vehicle interior, thereby heating the interior of the vehicle. Accordingly, heat loss occurred through the floor duct 15 or the console duct 16.

By directly heating the flowing air through the heating module that emits heat and simultaneously implementing direct heat radiation to the occupants, the vehicle heating device 1 is capable of improving heating performance and heating quality for occupants, who are the heating targets, while minimizing heat loss through the ducts.

While the vehicle heating device 1 is illustrated performing convection through the blower unit 20 and heat radiation from the heating unit simultaneously, the operation is not limited thereto. For example, the vehicle heating device 1 may selectively implement at least one of convection or heat radiation under the control of a control unit (not shown). Here, the control unit may be the electronic control unit (ECU) of the vehicle. In detail, it is possible to implement heating through convection by only operating the air conditioning system or to implement heating through radiation by only operating the vehicle heating device 1.

Additionally, a door 30 controlled by the control unit may also be arranged in the floor duct 15. The door 30 may regulate or block the airflow moving along the floor duct 15.

To distinguish between the door 14 located inside the air conditioning case 11 and the door 30 placed in the floor duct 15, the door 14 positioned inside the air conditioning case 11 may be referred to as the first door, while the door 30 installed in the floor duct 15 may be termed as the duct door or the second door. While the door 30 is illustrated as being positioned in the floor duct 15, this arrangement is not the only possible configuration. For example, the door 30 may be positioned inside the housing of the vehicle heating device 1 or in the console duct 16.

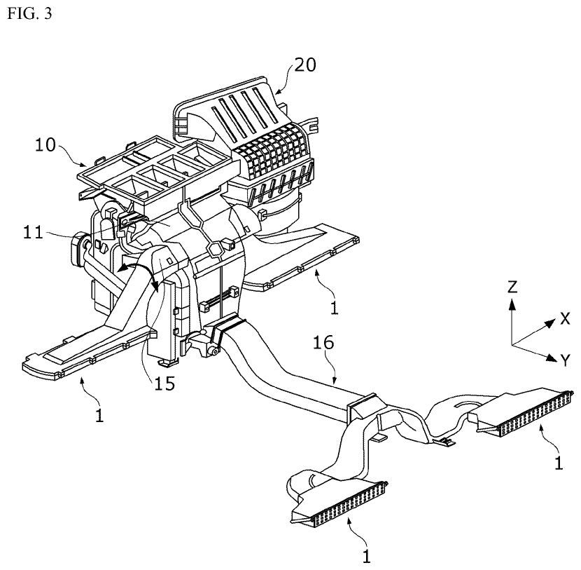

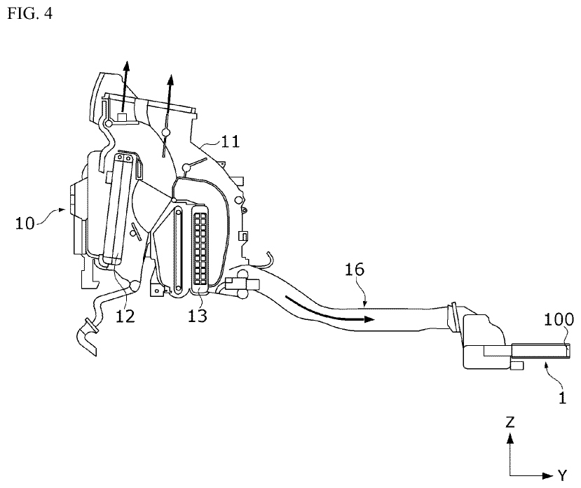

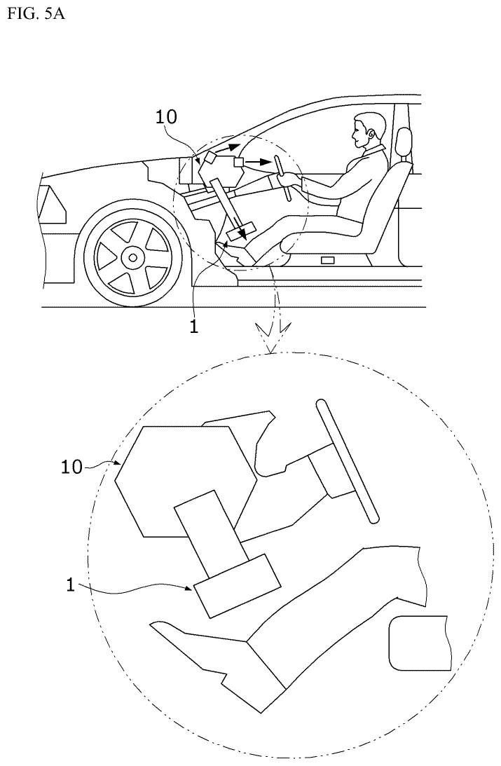

FIG. 3 is a perspective view illustrating a vehicle air conditioning system and a vehicle heating device according to an embodiment, FIG. 4 is a cross-sectional view illustrating a vehicle air conditioning system and a vehicle heating device according to an embodiment, FIG. 5A is a diagram illustrating a vehicle heating device heating around the ankles of an occupant according to an embodiment, and FIG. 5B is a diagram illustrating a vehicle heating device heating around the calves of an occupant according to an embodiment. In FIGS. 3 and 4, the X-direction may represent the width of the vehicle, the Y-direction the front-to-back direction of the vehicle body, and the Z-direction the up-down direction.

With reference to FIGS. 3 and 4, the vehicle heating device 1 may be positioned on both sides of the air conditioning case 11. For example, for the driver and passenger seats, at least two vehicle heating devices 1 may be placed on both sides of the air conditioning case 11 along the width direction, adjacent to the driver's or passenger's seat with a predetermined distance to ensure proper heating.

The vehicle heating device 1 may also be positioned on both sides of the console duct 16. Here, the console duct 16 may be one of the outlet ducts formed for air conditioning for passengers in the rear seats of the vehicle.

In addition, the vehicle heating device 1 may be detachably mounted on the floor duct 15 and console duct 16 to facilitate maintenance.

Moreover, the vehicle heating device 1 may be rotatably mounted on the floor duct 15 and console duct 16 to adjust the heating angle. Consequently, the vehicle heating device 1 may enhance heating performance and quality for the occupants.

As shown in FIG. 5A, the vehicle heating device 1 may pivot to heat around the ankles of the occupants. As shown in FIG. 5B, the vehicle heating device 1 may pivot to heat around the calves of the occupants.

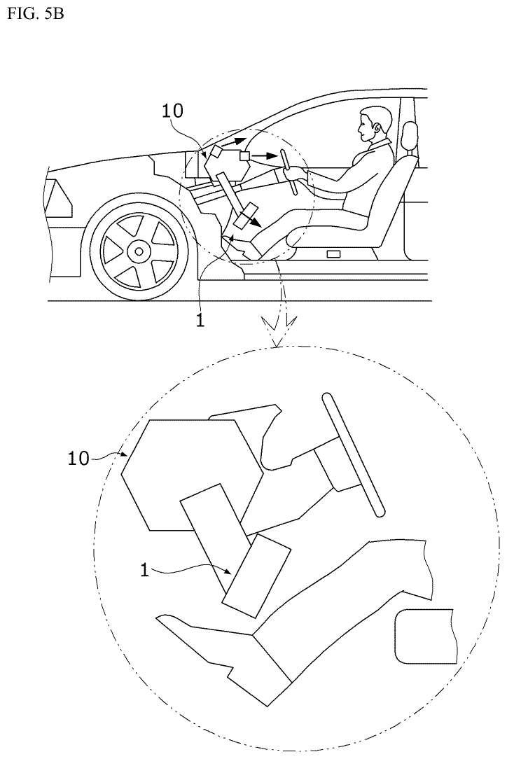

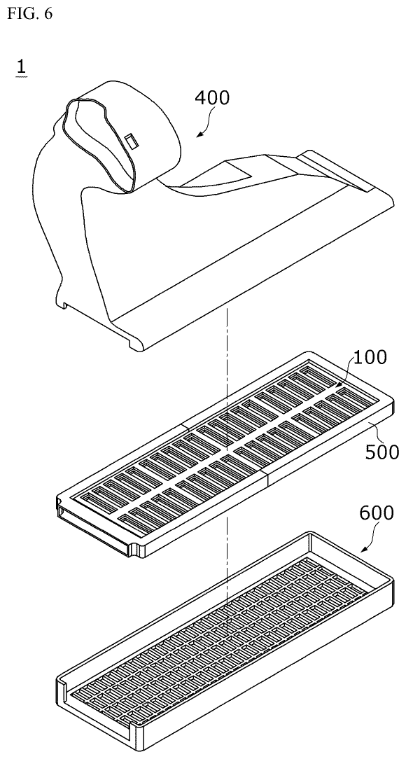

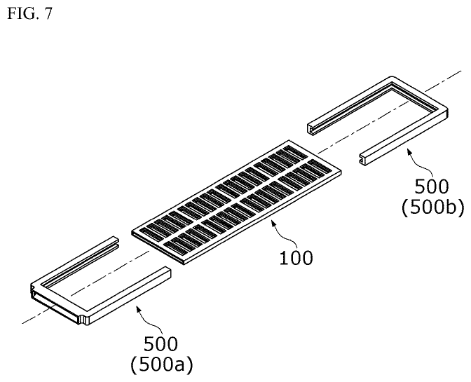

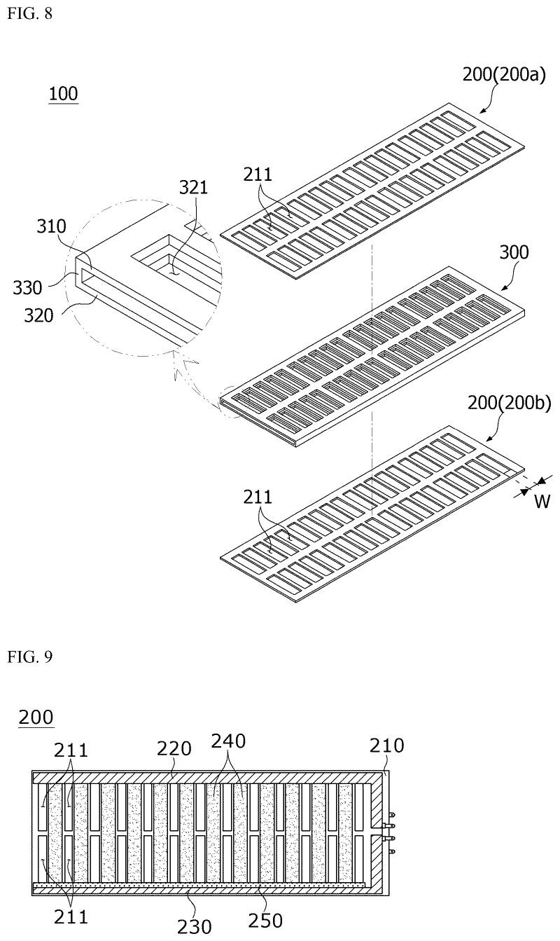

FIG. 6 is an exploded perspective view illustrating a vehicle heating device according to an embodiment, FIG. 7 is a diagram illustrating the arrangement relationship between a heating module and a support member in a vehicle heating device according to an embodiment; and FIG. 8 is an exploded perspective view illustrating a heating module of a vehicle heating device according to an embodiment.

With reference to FIGS. 6 to 8, the vehicle heating device 1 may be positioned towards the occupants on the airflow path connected to the air conditioning unit 10 and may include a heating module 100 that emits heat. The heating module 100 may include a heating unit 200 and a frame 300 supporting the heating unit 200.

In this case, the heating unit 200 may implement an overheating prevention structure to prevent overheating. Here, overheating of the heating unit 200 occur when foreign matter adheres to the holes formed in the heating module 100 to allow air to pass through, obstructing the airflow. Overheating of the heating unit 200 may also occur when the heating unit 200 operates even though the interior of the vehicle heating device 1 is in a windless state, causing the heating unit 200 to heat up above the preset temperature.

Additionally, the vehicle heating device 1 may further include a housing 400 inside which the heating module 100 is positioned, and a support member 500 supporting the heating module 100 to be arranged in the housing 400.

The vehicle heating device 1 may further include safety devices such as a cover 600 and a sensor 700.

Meanwhile, the vehicle heating device 1 may be implemented in a form where only the heating module 100 emitting heat is installed independently at the end of the floor duct 15 or console duct 16. In this case, the vehicle heating device 1 may achieves a compact size to secure interior vehicle space.

Alternatively, the vehicle heating device 1 may utilize the housing 400 to allow the heating module 100 to be detachably and rotatably installed at the end of the floor duct 15 or console duct 16.

With reference to FIG. 7, the heating module 100 may include a heating unit 200 emitting heat and a frame 300 supporting the heating unit 200. Here, the frame 300 may be formed of a metallic material with thermal conductivity to maintain a close relationship with the heating unit 200 and the surrounding temperature. Accordingly, the heat generated from the heating unit 200 may be transferred to the frame 300 via thermal conduction.

The heating unit 200 may minimize heat loss through the floor duct 15 and console duct 16, which are formed with a predetermined length, by raising the temperature of the air heated by the heater 13. For example, since the heater 13 heats the air to a lower temperature of around 40 degrees than the heating temperature at which the air was previously heated, heat loss through the floor duct 15 and console duct 16 may be minimized.

The heating unit 200 may heat the air passing through the heating unit 200 and discharge the heated air, thereby heating the vehicle interior through convection.

In addition, the heating unit 200 may implement direct heating for the occupants through radiant heat. For example, the heating unit 200 may be arranged facing the occupants. Accordingly, the heating unit 200 may implement direct heating for the occupants using radiant energy.

Here, the heating unit 200 may be provided as a planar heating element that generates heat using electricity. In this case, the heating unit 200 may be fixed to the outside of the frame 300 using a fixing member (not shown) such as an adhesive.

Meanwhile, a plurality of heating units 200 may be arranged on the frame 300 at mutually spaced intervals, forming a plurality of heat exchange areas. For example, at least two heating units 200 may be installed on the frame 300 at a predetermined interval. This may create a plurality of heat exchange zones facilitating heat exchange between the heating unit 200 and the air.

With reference to FIG. 7, the heating units 200 may be arranged to be spaced apart from each other in the direction of airflow or vertically. In this case, the two heating units 200 may be formed in two layers and may be distinguished as upper heating unit 200a and lower heating unit 200b based on their placement. This configuration allows for heat exchange between the air flowing through the heating units 200 and the heat emitted from both the upper and lower heating units 200a and 200b within their respective heat exchange zones. Here, the upper heating unit 200a may be referred to as the first heating unit, and the lower heating unit 200b may be referred to as the second heating unit.

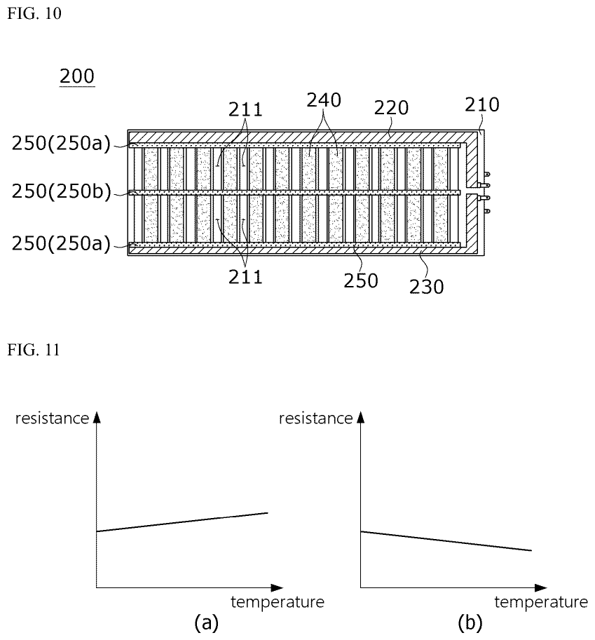

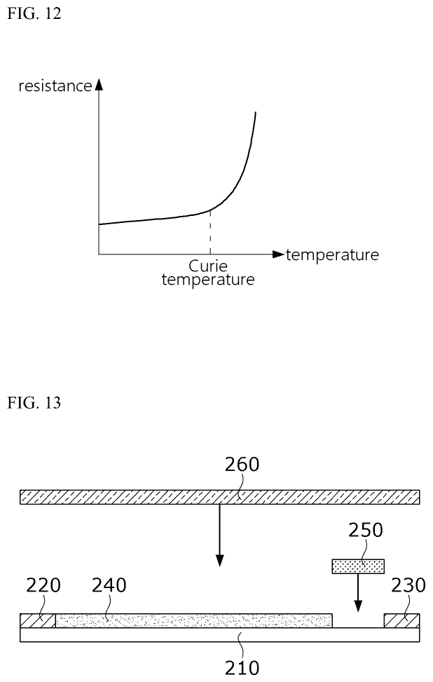

FIG. 9 is a diagram illustrating a planar heating unit arranged in a heating module of a vehicle heating device according to an embodiment, FIG. 10 is a diagram illustrating a variant of the planar heating unit arranged in a heating module of a vehicle heating device according to an embodiment, FIG. 11 depicts graphs illustrating the relationship between resistance and temperature for a first heating element arranged in a heating unit of a vehicle heating device according to an embodiment, and FIG. 12 depicts a graph illustrating the relationship between resistance and temperature for a second heating element arranged in a heating unit of a vehicle heating device according to an embodiment. In FIG. 11, (a) shows a graph of the linear increase in resistance relative to the temperature of the first heating unit, and (b) shows a graph of the linear increase in resistance relative to the temperature of the first heating unit.

With reference to FIGS. 9 and 10, the heating unit 200 may include a planar body 210 with a plurality of holes 211 formed thereon, a first electrode 220 and a second electrode 230 arranged on the body 210, and a first heating element 240 and a second heating element 250 positioned on the body 210 to be serially connected between the first electrode 220 and the second electrode 230. Both the first and second heating elements 240 and 250 may be referred as heating elements.

Here, the first and second heating elements 240 and 250 may be formed from different materials with varying rates of change in electrical resistance at predetermined temperatures to implement the overheating prevention structure as described above. Accordingly, the heating unit 200 may be prevented from overheating beyond a predetermined temperature.

The body 210 may be formed in a planar shape. For example, the body 210 may be formed in a film shape. In this case, the body 210 may be formed from an insulating material. For example, the body 210 may be formed from synthetic resin material.

The body 210 may also be formed in a rectangular shape where the width in the first direction is greater than the width in the second direction. Here, the first direction may refer to a direction different from the second direction and may be referred to as the length direction. The second direction may be referred to as the width direction. The first and second directions may be defined as perpendicular to each other in the plane. The first direction may be the vehicle's width direction.

The body 210 may include a plurality of holes 211 formed by being penetrated through blanking forming. Accordingly, the air supplied into the interior through the inlet of the housing 400 may be guided and discharged through the holes 211. Here, the holes 211 may be formed in various shapes considering the hole structure of the frame 300 and air conditioning quality, and may be referred to as first holes, body holes, or ventilation holes. The body 210 may be referred to as the first body or heating element body.

The first and second electrodes 220 and 230 may supply power to the first and second heating elements 240 and 250. Here, the first electrode 220 may be the positive electrode, while the second electrode 230 may be the negative electrode.

The first and second electrodes 220 and 230 may be arranged spaced apart from each other in the second direction. The first and second heating elements 240 and 250 may be arranged to be electrically connected in series between the first and second electrodes 220 and 230.

In addition, a terminal may be arranged on one side of each of the first and second electrodes 220 and 230 for connection to an external power source.

The first heating element 240 may dissipate heat by the power supplied through the first and second electrodes 220 and 230. The first heating element 240 may be formed in a planar shape. Here, the power may be controlled by the control unit.

The first heating element 240 may also be formed on the body 210 using a printing method with carbon-based ink or other ink with resistance. Here, while the first heating element 240 is exemplified as being formed on the body 210 using a printing method, this method is not the only one possible. For example, the first heating element 240 may also be formed on the body 210 using an etching method, which creates a planar heating pattern on a thin film material. Alternatively, the first heating element 240 may be formed by arranging a heating element, such as a PTC element, on the body 210. However, when using a printing method, the first heating element 240 may be formed along with the electrodes 220 and 230, thereby reducing the number of manufacturing processes and improving productivity.

Meanwhile, the first heating element 240 may be positioned adjacent to the holes 211. Here, “adjacent” may mean being positioned in contact or at a predetermined distance apart.

Here, since a plurality of holes 211 are arranged at intervals from each other, the first heating element 240 may also be arranged at intervals from each other. For example, the plurality of the first heating elements 240 may be arranged at intervals in the first direction. As shown in FIGS. 9 and 10, the holes 211 may be arranged between the first heating elements 240. In detail, the holes 211 and the first heating elements 240 may be alternately arranged in the first direction between the first electrode 220 and the second electrode 230, which are arranged spaced apart from each other in the second direction. Accordingly, the first heating elements 240 may efficiently heat the air.

The first heating element 240 may be formed in a rectangular shape with one side wider than the other. For example, the first heating element 240 may be formed in a rectangular shape where the width in the second direction relative to the body 210 is greater than the width in the first direction.

In this case, one side of the first heating element 240 may be electrically connected to the first electrode 220 or the second electrode 230, but this is not necessarily the only way. For example, the first heating element 240 may also be electrically connected to the first electrode 220 and the second electrode 230 through the intermediary of the second heating element 250.

As shown in FIG. 9, one side of the first heating element 240 may be electrically connected to the first electrode 220, while the other side may be electrically connected to the second heating element 250.

Also, as shown in FIG. 10, one side and the other side of the first heating element 240 may be electrically connected to the second heating element 250. In this case, the second heating element 250 may be placed between the two first heating elements 240 to electrically connect the two first heating elements 240. By using a plurality of second heating elements 250 to electrically connect the first heating element 240 to the electrodes 220 and 230, it is possible to effectively address localized overheating in the heating unit 200 compared to when only one second heating element 250 is deployed.

With reference to FIG. 11, the first heating element 240 may be formed from a material with a linear rate of change of resistance with respect to temperature. In other words, the first heating element 240 may be made from a material that exhibits a linear resistance response to temperature variations.

The first heating element 240 may be formed from a material with a relatively smaller rate of change of resistance with respect to temperature compared to the second heating element 250. Accordingly, considering heat generation, the total area of the first heating element 240 may be larger than the total area of the second heating element 250.

With reference to (a) in FIG. 11, the first heating element 240 may be formed from a material whose resistance increases with increasing temperature. In other words, the first heating element 240 may be formed from a material that exhibits a positive temperature coefficient (PTC) while also having a linear increase in resistance with temperature. Here, the first heating element 240 may have a resistance change rate of 50% or less based on a temperature change of 100 degrees. Therefore, as the temperature increases, the resistance of the first heating element 240 may also increase. The first heating element 240 made of such material may enhance price competitiveness by facilitating printing along with electrodes 220 and 230.

With reference to (b) in FIG. 11, the first heating element 240 may be formed from a material whose resistance decreases with increasing temperature. That is, the first heating element 240 may be formed from a material that exhibits a negative temperature coefficient (NTC) characteristic while also having a linear decrease in resistance with temperature. Here, the first heating element 240 may have a resistance change rate of 50% or less based on a temperature change of 100 degrees. Accordingly, the resistance of the first heating element 240 may decrease as the temperature increases. The first heating element 240 made of such material has advantages of high thermal radiation capability, thermal conductivity, and durability.

The second heating element 250 may dissipate heat by the power supplied through the first electrode 220 and the second electrode 230. Additionally, the second heating element 250 may be formed in a planar shape. Here, the power may be controlled by the control unit.

The second heating element 250 may also be formed on the body 210 using a printing method with carbon-based ink or other ink with resistance. Alternatively, the second heating element 250 may also be formed using etching method or by arranging heating elements, similar to the first heating element 240.

Also, at least one second heating element 250 may be arranged adjacent to the holes 211.

As shown in FIG. 9, one second heating element 250 may be arranged adjacent to the holes 211 in the first direction. In this case, a plurality of first heating elements 240 may be electrically connected on one side of the second heating element 250, while the second electrode 230 may be electrically connected on the other side. Here, while the second heating element 250 is exemplified as being electrically connected to the second electrode 230, this arrangement is not the only one possible. For example, the second heating element 250 may also be arranged to be electrically connected to the first electrode 220.

As shown in FIG. 10, three second heating elements 250 may be arranged adjacent to the holes 211 and spaced apart from each other along the first direction. Here, the first heating elements 240 may be electrically connected between the second heating elements 250 in the second direction. In this case, the second heating elements 250 may include second-1 heating elements 250a positioned between the electrodes 220 and 230 and the first heating element 240, and a second-2 heating element 250b positioned between the first heating elements 240.

The second heating element 250 may be formed in a rectangular shape with one side wider than the other. For example, the second heating element 250 may be formed in a rectangular shape where the width in the first direction relative to the body 210 is greater than the width in the second direction.

With reference to FIG. 12, the second heating element 250 may be formed from a material with a non-linear rate of change of resistance with temperature. In other words, the first heating element 240 may be made from a material that exhibits a non-linear resistance response to temperature variations.

The second heating element 250 may be formed from a material with a relatively larger rate of change of resistance with temperature at predetermined temperatures compared to the first heating element 240. Accordingly, considering heat generation, the total area of the second heating element 250 may be smaller than the total area of the first heating element 240.

With reference to FIG. 12, the second heating element 250 may be formed from a material whose resistance sharply increases a predetermined temperatures. Here, the second heating element 250 may be formed from a material that exhibits a resistance change of more than 10 times compared to the resistance at room temperature.

Particularly, the second heating element 250 may have a characteristic of suppressing overcurrent by exhibiting a sharp increase in electrical resistance at temperatures above the Curie temperature (transition temperature), thereby reducing the flowing current. Due to this characteristic, the second heating element 250 possesses a self-temperature stabilization function, and by being connected in series with the first heating element 240, can suppress overheating of the heating unit 200. Here, the Curie temperature may be formed in the range of 100 to 140 degrees Celsius.

Therefore, the second heating element 250 may prevent the heating unit 200 from overheating while raising the temperature of the air. In other words, the second heating element 250 may simultaneously possess heating capability and overheating prevention capability.

In detail, the first heating element 240 and the second heating element 250 may be connected in series between the first electrode 220 and the second electrode 230.

When the heating unit 200 overheats, both the first heating element 240 and the second heating element 250 rise above the Curie temperature. Here, since the second heating element 250 is formed from a material in which the electrical resistance sharply increases at temperatures above the Curie temperature, the resistance of the second heating element 250 sharply increases above the Curie temperature.

Consequently, the total resistance of the first heating element 240 and the second heating element 250 increases. As the total resistance increases, the current flowing through the first heating element 240 and the second heating element 250 decreases, thereby allowing the second heating element 250 to prevent overheating of the heating unit 200.

Meanwhile, temporarily interrupting the power supplied to the heating unit 200 may also prevent overheating of the heating unit 200. Accordingly, the vehicle heating device 1 can achieve temperature stabilization of the heating unit 200.

On the other hand, the heating unit 200 may be implemented in various shapes due to the flexible structure of the body 210, the size, shape, and placement of the holes 211, electrodes 220 and 230, and the first and second heating elements 240 and 250. Accordingly, the design flexibility of the heating unit 200 can be enhanced.

FIG. 13 is a diagram illustrating the manufacturing process of a heating unit of a vehicle heating device according to an embodiment.

With reference to FIG. 13, the electrodes 220 and 230 and the first heating element 240 may be formed on the body 210 through a printing method. Then, the second heating elements 250 with different materials may be formed using the printing method as well.

As the heating unit 200 is formed by applying the printing method twice, it is possible to reduce manufacturing process compared to other methods. Consequently, the production cost of the heating unit 200 can be reduced.

To protect the exposed electrodes 220 and 230, first heating element 240, and second heating element 250, the heating unit 200 may further include a cover member 260.

The cover member 260 may be formed from an insulating material such as synthetic resin and may be arranged to cover the electrodes 220 and 230, the first heating element 240, and the second heating element 250. The cover member 260 may be formed from the same material as the body 210.

The frame 300 may support the heating unit and may include multiple holes formed to allow airflow.

The frame 300 may be formed from a highly thermally conductive metal material to closely interact with the surrounding temperature in addition to the heating unit 200. For example, the frame 300 may be formed from a material such as aluminum. Accordingly, the frame 300 may facilitate heat exchange with the air passing through the vehicle heating device 1 by dissipating the heat from the heating elements 240 and 250. Therefore, the frame 300 facilitates the heating of the vehicle interior.

The holes may be formed to correspond to the holes 211 of the heating unit 200. Accordingly, air can be supplied to the vehicle interior through the holes of the frame 300 and the holes 211 of the heating unit 200. Here, the holes formed in the frame 300 may be referred to as second holes or frame holes.

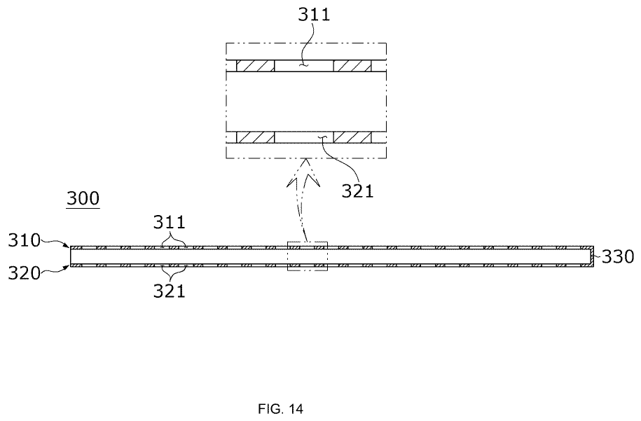

FIG. 14 is a cross-sectional view illustrating a frame of a vehicle heating device according to an embodiment.

With reference to FIGS. 8 and 14, the frame 300 may include an upper plate 310 with a plurality of holes 311, a lower plate 320 with a plurality of holes 321 arranged offset from and below the upper plate 310, and side walls 330 connecting the edges of the upper plate 310 and the lower plate 320. The holes 311 formed in the upper plate 310 may be referred to as upper plate holes or second upper frame holes, while the holes 321 formed in the lower plate 320 may be referred to as lower plate holes or second lower frame holes.

The upper plate 310, lower plate 320, and sidewalls 330 form the exterior of the frame 300 and may create an internal space. This space may serve as a heat exchange area, enhancing thermal efficiency. That is, the frame 300 improves the thermal efficiency of the heating unit 200 by allowing air to temporarily reside in the space.

The upper plate 310 may be formed in the shape of a plate with a predetermined thickness. The upper plate 310 may include a plurality of holes 311 formed to penetrate in the vertical direction for airflow.

The upper heating unit 200a may be arranged on the upper surface of the upper plate 310.

The lower plate 320 may be formed in the shape of a plate shape with a predetermined thickness. The lower plate 320 may include a plurality of holes 321 formed to penetrate in the vertical direction for airflow.

The holes 321 of the lower plate 320 may be arranged to overlap with the holes 311 of the upper plate 310 in the direction of airflow.

The lower plate 320 may be formed to be spaced apart from the upper plate 310 by a predetermined distance. As a result, a heat exchange area may be formed between the upper plate 310 and the lower plate 320.

To provide radiative heating to the passengers, the lower surface of the lower plate 320 may accommodate the lower heating unit 200b.

Meanwhile, a protrusion pattern such as a stud may be formed in the holes 211 of the lower plate 320. The protrusion pattern may increase the residence time of the air in the heat exchange area formed between the upper plate 310 and the lower plate 320. As a result, the heat exchange efficiency in the heat exchange area can be improved.

The side wall 330 is interposed between the upper plate 310 and the lower plate 320 to provide structural support for the upper and lower plates 310 and 320. In this case, considering the size of the space formed inside the frame 300, the side wall 330 may be arranged to connect the ends of the upper plate 310 and the lower plate 320.

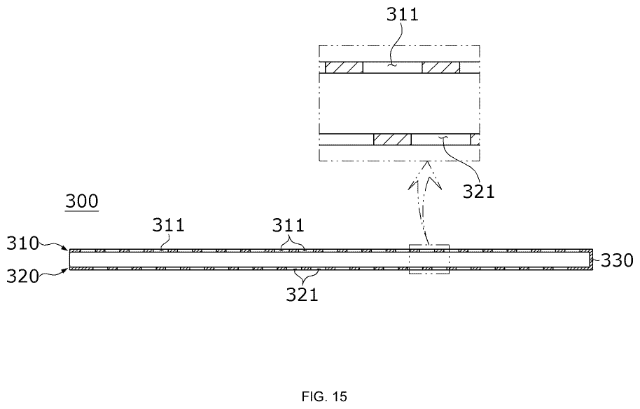

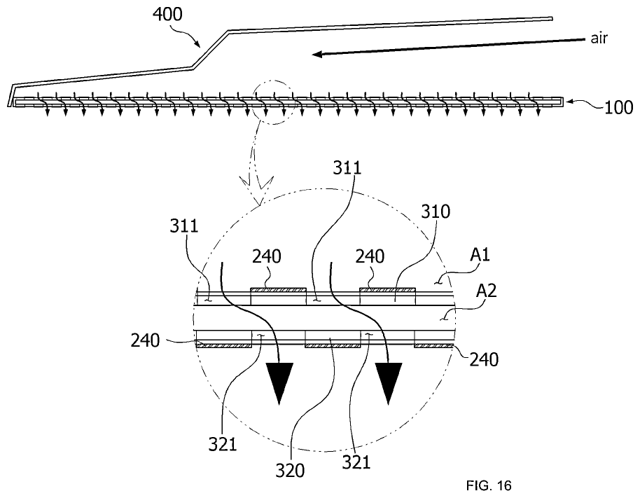

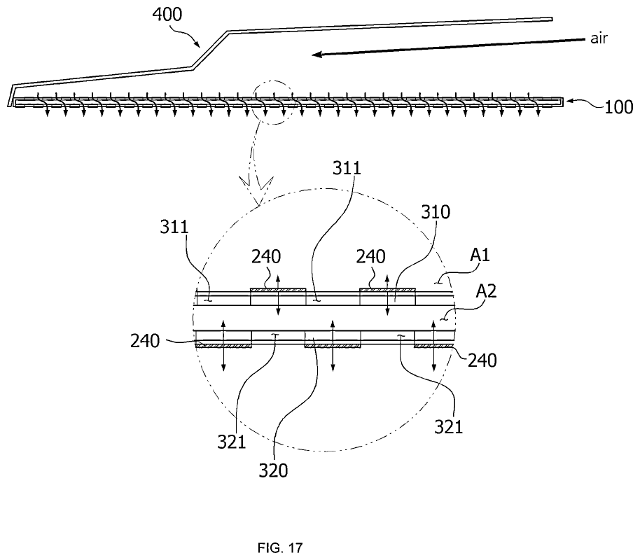

FIG. 15 is a cross-sectional view illustrating a frame of a vehicle heating device according to another embodiment, FIG. 16 is a diagram illustrating the airflow through a heating module with a housing and a frame arranged in the vehicle heating device according to an embodiment, and FIG. 17 is a diagram the heat exchange through a heating module with a housing and a frame arranged in the vehicle heating device according to an embodiment. In FIG. 16, solid arrows may represent the flow of air. In FIG. 17, dashed arrows may represent the dissipation of heat.

With reference to FIG. 15, the holes 311 of the upper plate 310 and the holes 321 of the lower plate 320 may be in a zigzag pattern. In other words, the holes 311 in the upper plate 310 and the holes 321 in the lower plate 320 may be arranged not to overlap. Accordingly, the residence time in the space between the upper plate 310 and the lower plate 320 may further increase.

As shown in FIGS. 16 and 17, the upper surface of the upper plate 310 may accommodate the upper heating unit 200a based on the airflow. For example, considering the efficiency of heat exchange with the heat exchange area formed in front of the upper heating unit 200a and the increase in the area of the upper heating unit 200a, the upper heating unit 200a can be positioned on the upper surface of the upper plate 310 based on the airflow.

With reference to FIGS. 16 and 17, the heat exchange area may include a first heat exchange area A1 formed at the forefront (upstream side) of the upper heating unit 200a, and a second heat exchange area A2 formed between the upper heating unit 200a and the lower heating unit 200b, based on the direction of airflow inside the vehicle heating device 1. That is, the second heat exchange area A2 may be formed between the upper plate 310 and the lower plate 320.

The first heat exchange area A1 may be a region where the air, moving along the housing 400, exchanges heat with the radiant heat emitted from the heating elements 240 and 250 of the upper heating unit 200a. Thus, the first heat exchange area A1 may be formed inside the housing 400 and may be referred to as the preheating area.

The second heat exchange area A2 may be situated between the upper heating unit 200a and the lower heating unit 200b with respect to the airflow direction and may be formed inside the frame 300. Here, both the upper heating unit 200a and the lower heating unit 200b may be positioned on the outer sides, namely, the upper and lower sides of the frame 300.

Consequently, the air flowing between the upper heating unit 200a and the lower heating unit 200b may exchange heat with the radiant heat emitted from each of the upper heating unit 200a and the lower heating unit 200b. In detail, the air passing through the holes 211 of the upper heating unit 200a mixes in the second heat exchange area A2 before passing through the holes 211 of the lower heating unit 200b, exchanging heat with the heat emitted from the upper heating unit 200a and the lower heating unit 200b.

Furthermore, by arranging the holes 211 of the upper heating unit 200a and the holes 211 of the lower heating unit 200b in an offset manner with respect to the airflow direction, the heating performance can be enhanced. For example, by arranging the holes 211 of the upper heating unit 200a and the first heating element 240 of the lower heating unit 200b to overlap in one direction (either the direction of airflow or vertically), the air passing through the holes 211 of the upper heating unit 200a may flow along the heating elements 240 and 250 of the lower heating unit 200b, thereby further increasing the residence time of the air in the second heat exchange area A2.

Additionally, arranging the first heating element 240 of the upper heating unit 200a to overlap with the holes 211 of the lower heating unit 200b in one direction may enhance the radiant heating performance. Consequently, this arrangement may improve the heating efficiency and performance of the vehicle heating device 1.

Furthermore, by forming the shapes of the holes 211 of the upper heating unit 200a and the lower heating unit 200b differently, the residence time of the air in the second heat exchange area A2 may be further increased. For example, by forming protrusions or the like as residence elements (not shown) in the holes 211 of the lower heating unit 200b to induce turbulence, the residence time of the air in the second heat exchange area A2 may be further increased.

Meanwhile, the upper heating unit 200a and lower heating unit 200b may be controlled individually by the control unit. For example, the control unit may regulate the heating performance by controlling the power supplied to each of the upper heating unit 200a and the lower heating unit 200b.

The housing 400 may be connected to the floor duct 15. Consequently, the housing 400 may guide the air supplied through the floor duct 15. In this case, the housing 400 may include openings formed to discharge air towards the heating module 100.

The housing 400 may be formed in various shapes using injection molding of synthetic resin materials like plastic.

The support member 500 may be positioned between the housing 400 and the heating module 100 to support the heating unit 200.

To facilitate assembly with the heating module 100, the support member 500 may include a first support member 500a and a second support member 500b.

For sliding engagement with the heating module 100, the support member 500 may have grooves. Here, the grooves may guide the coupling between the heating module 100 and the support member 500.

Either the first support member 500a or the second support member 500b may have a hole. This hole may be formed to supply power to the heating unit 200.

The cover 600 may prevent direct contact between the heating unit 200 and human bodies or objects. The cover 600 may be made of synthetic resin materials such as plastic or metal.

The cover 600 may be arranged to cover one side of the heating module 100. As shown in FIG. 6, the cover 600 may be positioned on one side of the heating module 100, namely the lower side, and coupled to the opening side of the housing 400 to prevent detachment of the heating module 100. For example, the cover 600 may be coupled to the housing 400 using hooks or other means that engage with protrusions formed on the side of the housing 400.

The cover 600 may also have a plurality of holes formed for the discharge of air.

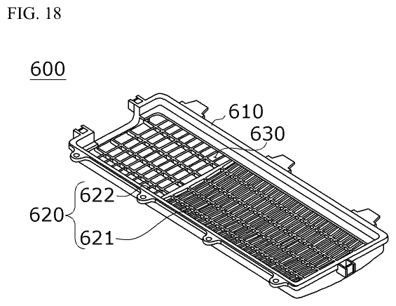

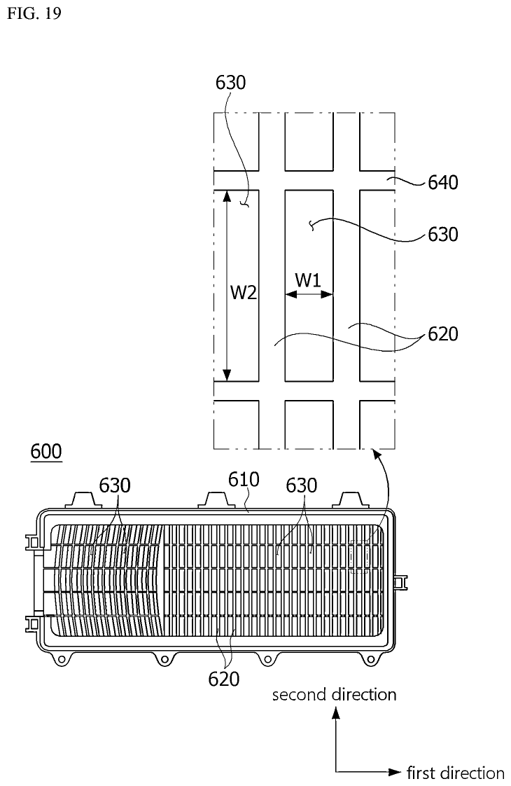

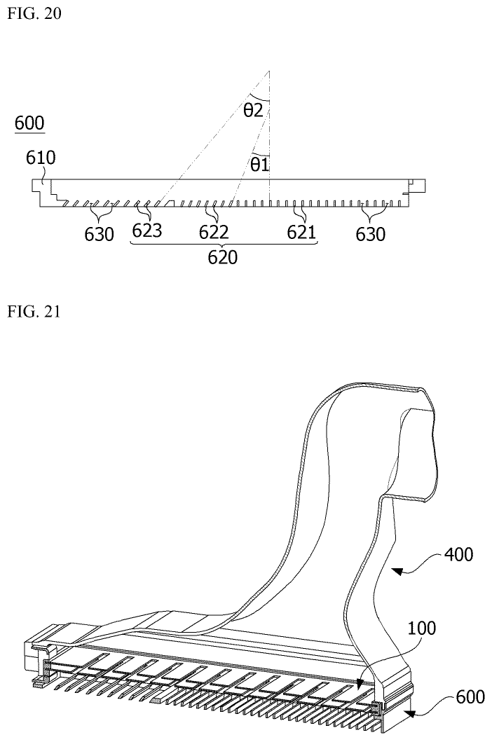

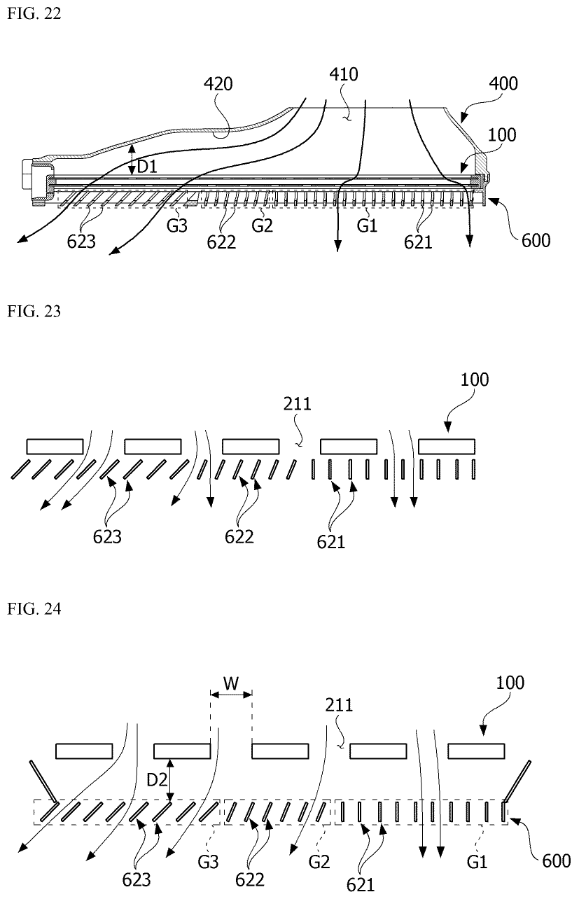

FIG. 18 is a perspective view illustrating a cover of a vehicle heating device according to an embodiment, FIG. 19 is a plan view illustrating a cover of a vehicle heating device according to an embodiment, FIG. 20 is a cross-sectional view illustrating a cover of a vehicle heating device according to an embodiment, FIG. 21 is a cross-sectional view illustrating a vehicle heating device with a cover according to another embodiment, FIG. 22 is a diagram illustrating the air flow in a vehicle heating device with a cover according to another embodiment, FIG. 23 is a diagram illustrating a guide arranged close to a heating module of a vehicle heating device according to an embodiment, and

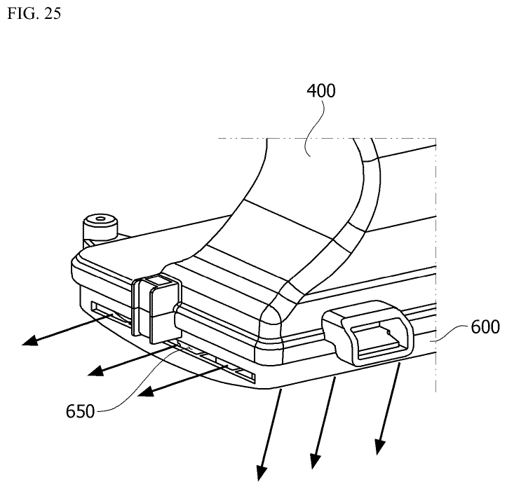

FIG. 24 is a diagram illustrating a guide arranged to maintain a predetermined distance from a heating module of a vehicle heating device according to an embodiment. In FIGS. 22, 23, and 24, solid arrows may represent the flow of air.

With reference to FIGS. 18 to 20, the cover 600 may include a cover body 610 and a plurality of guides 620 arranged spaced apart on one surface of the cover body 610. As the guides 620 are spaced apart, guide holes 630 may be formed between the guides 620. Additionally, the cover 600 may include a plurality of ribs 640 arranged to secure the rigidity of the guides 620. The ribs 640 may be arranged in the vehicle width direction or the first direction. The guides 620 may be arranged in the second direction

Accordingly, the arrangement of the plurality of guides 620 and ribs 640 may form a plurality of guide holes 630.

As shown in FIG. 19, the guide holes 630 may be formed in a rectangular shape with a first width W1 and a second width W2. Here, the first width W1 may be the shortest width of the guide hole 630 and may be smaller than the second width W2. The shortest width may be 2 mm or more. Preferably, the shortest width may be in the range of 2 mm to 7 mm.

While the guide hole 630 is exemplified as being formed in a rectangular shape herein, this shape is not the only one possible. For example, the guide hole 630 may be formed in various shapes, such as circular, oval, or hexagonal, considering the appearance and matching with the holes of the heating module 100. Even when formed in various shapes such as circular, oval, or hexagonal, the guide hole 630 may still have a shortest width.

The guides 620 may direct the air discharged into the vehicle interior. Here, part of the plurality of guides 620 may be arranged to have a predetermined angle (slope) with respect to the air flow, thereby enhancing heating performance and quality for the occupants.

In detail, the housing 400 may have an opening larger than the inlet 410 through which air is drawn in, to enhance the heating effect for the occupants. Accordingly, the velocity of airflow may be reduced as the air approaches the opening side of the above housing 400.

To address these issues, the vehicle heating device 1 may ensure heating for the occupants by optimizing airflow and direction in such a way as to adjust the distance D1 between the inner surface 420 of the housing 400 and the heating module 100, the inclination of the guides 620, and the distance D2 between the heating module 100 and the guides 620. The distance D1 between the inner surface 420 of the housing 400 and the heating module 100 may be referred to as the first separation distance or the first distance, while the distance D2 between the heating module 100 and the guides 620 may be referred to as the second separation distance or the second distance. The inner surface 420 may be the upper interior surface of the housing.

As shown in FIG. 19, the vehicle heating device 1 may be configured such that the distance D1 between the inner surface 420 of the housing 400 and the heating module decreases as the distance from the inlet 410 increases, thereby minimizing the reduction in air velocity.

Furthermore, the guides 620 may be arranged at certain angles to provide heated air to both feet of the occupant even when the vehicle heating device 1 is positioned biased towards one of the occupant's feet. In particular, the guides 620 have a larger inclination angle as the distance from the inlet 410 of the housing increases such that the vehicle heating device 1 is capable of allowing air to be easily discharged to both feet of the occupant.

In addition, the vehicle heating device 1 ensures directional control functionality by providing a predetermined separation distance D2 between the heating module 100 and the guides 620.

By employing a plurality of guides 620 with different inclination angles in this manner, it is possible to achieve an optimized heating effect.

The guides 620 may include a plurality of first guides 621 spaced apart from each other, a plurality of second guides 622 spaced apart from each other, and a plurality of third guides 623 spaced apart from each other. In this case, the guides 620 may form an optimized airflow through a first group G1 consisting of the plurality of first guides 621, a second group G2 consisting of the plurality of second guides 622, and a third group G3 consisting of the plurality of third guides 623.

The first guides 621 may be arranged in the direction of airflow passing through the heating module 100, i.e., in the vertical direction. In this case, the first guides 621 may be positioned beneath the inlet 410. Accordingly, the inlet 410 and the first guides 621 may be arranged to overlap in the vertical direction.

The second guides 622 and third guides 623 may be inclined with respect to the airflow, being arranged to have certain slopes. In this case, the second guides 622 may be positioned farther from the inlet 410 than the first guides 621. The third guides 623 may be positioned farther from the inlet 410 than the second guides 622.

In detail, the second guides 622 may be arranged to have a predetermined first inclination angle θ1 relative to the first guides 621. The third guides 623 may be positioned to have a predetermined second inclination angle θ2 relative to the first guides 621. Here, the first inclination angle θ1 may be smaller than the second inclination angle θ2. That is, as the guides move farther away from the inlet 410, the inclination angles of the guides 620 may increase. As a result, the second guides 622 and third guides 623 may provide the occupant with an optimized direction of airflow.

In particular, the third guides 623, which have a relatively greater inclination angle compared to the second guides 622, may bias the airflow towards body parts that feel colder, thereby enhancing the air conditioning quality for the occupants.

FIGS. 21 and 22 show an alternate configuration of the cover 600 and the housing 400 according to another embodiment. Here, the guides 620 may be formed to have a predetermined second separation distance D2 from the heating module 100.

In detail, the guides 620 may be positioned at a predetermined second separation distance D2 from the heating module 100 to prevent the guides 620 from reaching a burn temperature due to the heat generated by the heating module 100 or to ensure that the air passing through the holes of the heating module 100 is smoothly directed by the guides 620 and discharged towards the occupants. In this case, the holes of the heating module 100 may be the holes 211 of the heating unit 200 or the holes of the frame 300 corresponding to the holes 211 of the heating unit 200.

Hereinafter, the arrangement relationship between the holes 211 of the heating unit 200 and the separation distance D2 will be examined to understand the arrangement relationship between the holes of the heating module 100 and the second spacing distance D2.

As shown in FIG. 23, placing the guides 620 too close to the heating module 100 risks the guide reaching a burn temperature.

Additionally, when the guides 620 are placed too close to the heating module 100, part of the air passing through the hole 211 may not pass through some of the guide holes 630. Consequently, the guides 620 cannot fulfill the intended function.

The vehicle heating device 1 may address the issues by providing optimized design criteria for the separation distance D2.

In detail, to address the issue of the guides 620 reaching burn temperatures, the guides 620 may be arranged at a predetermined separation distance D2 away from the heating module 100. For example, the separation distance D2 may be 3 mm or more. Here, the heating module 100 may rise to a preset temperature.

Based on this premise, to ensure the functionality of guiding air by the guides 620, the separation distance D2 may be further limited in relation to the area of the holes in the heating module 100, as follows.

That is, the vehicle heating device 1 may restrict the separation distance D2, taking into account both the temperature rise of the guide 620 to the point of burning and the function of the guides 620. Because the function of guide 620 is related to the area of the holes in heating module 100, the vehicle heating device 1 may provide an optimized range for separation distance D2 based on the relationship between the function of the guides 620 and the hole area in the heating module 100.

With reference to FIGS. 8 and 24, the holes in the heating module 100 may be formed in a rectangular shape, and based on this, the holes 211 in the heating unit 200 may also be formed in a rectangular shape. Accordingly, the holes 211 may have a shortest width W. Here, the shortest width W of the holes 211 may be 3 mm or more. Preferably, the shortest width W may be in the range of 3 mm to 20 mm. More preferably, the shortest width W may be formed within the range of 4 mm to 6 mm. Even more preferably, the shortest width W may be 4 mm.

Meanwhile, the second separation distance D2 may be equal to or smaller than the shortest width W of the holes 211.

For example, the second separation distance D2 may be smaller than or equal to 1 times the shortest width W of the holes 211. Preferably, the second separation distance D2 may be formed within the range of 0.15 to 1 times the shortest width W of the holes 211. More preferably, the second separation distance D2 may be formed within the range of 0.5 to 0.75 times the shortest width W of the holes 211. Even more preferably, the second separation distance D2 may be 0.75 times the shortest width W of the holes 211. That is, when the shortest width W of the holes 211 is 4 mm, the second separation distance D2 may be 3 mm, and based on these numerical relationships, the vehicle heating device 1 may provide optimal heating quality.

In addition, the shortest width W of the holes 211 may be greater than the shortest width of the guide holes 630. Consequently, the air passing through the holes 211 may be easily guided by the guides 620 while being adjusted in various directions.

FIG. 25 shows a cover formed with ventilation holes for a vehicle heating device according to another embodiment.

With reference to FIG. 25, the cover 600 may further include ventilation holes 650 formed on the side of the cover body 610. Here, the ventilation holes 650 may be referred to as air vents.

The ventilation holes 650 may communicate with the space formed between the heating module 100 and the guides 620.

Additionally, the ventilation holes 650 may be formed on one or each side of the cover body 610 in multiple numbers. The ventilation holes 650 may be formed in various shapes such as square, circular, or oval.

This facilitates the vehicle heating device 1 to increase airflow and diverse wind direction through the ventilation holes 650.

Meanwhile, it is preferably for the vehicle heating device 1 equipped with the guides 620 to be arranged to communicate with the floor duct 15.

The guides 620 may hinder the airflow due to resistance, diminishing the heating and cooling performance when placed in face vents or defroster vents of the air conditioning unit 10 that need to discharge air far away.

However, the floor duct 15, by design, directs air towards the vehicle's floor or occupants' feet, resulting in a relatively shorter distance from the target object. Consequently, even when the vehicle heating device 1 is installed in the floor duct 15, the practical benefit of improving heating performance and quality is greater than the decrease in air flow rate caused by the guides 620.

Therefore, the vehicle heating device 1 equipped with guides 620 may be arranged to connect with the floor duct 15.

The sensor 700 may detect human or object approaching the heating module 100. In this case, the sensor 700 may output a signal to cut off the power supplied to the heating module 100. The control unit may cut off the power supplied to the heating unit 200 based on that signal. Alternatively, the control unit may output sound, light, or other alerts to signal the approach based on the signal. Hence, the sensor 700 may be provided as one of the safety devices.

In this case, the sensor 700 may be a capacitance sensor capable of detecting the static capacitance of a person or object.

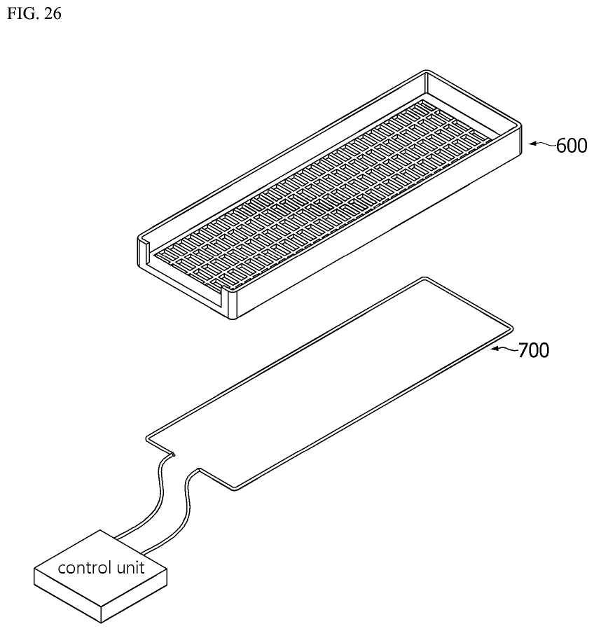

FIG. 26 is a diagram illustrating a sensor of a vehicle heating device according to an embodiment.

With reference to FIG. 26, the sensor 700 may be a sensing line that detects static capacitance. The sensor 700 may be electrically connected to the control unit. Accordingly, when the sensor 700 detects the approach of a human body, the control unit may cut off the power supplied to the heating unit 200.

The sensor 700 may be positioned on one side of the cover 600. For example, the sensor 700 may be disposed along the edge of the cover 600. Accordingly, the sensor 700 may effectively detect the approach of the occupant.

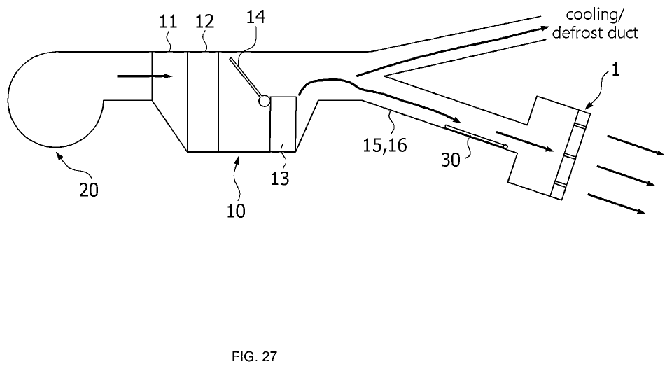

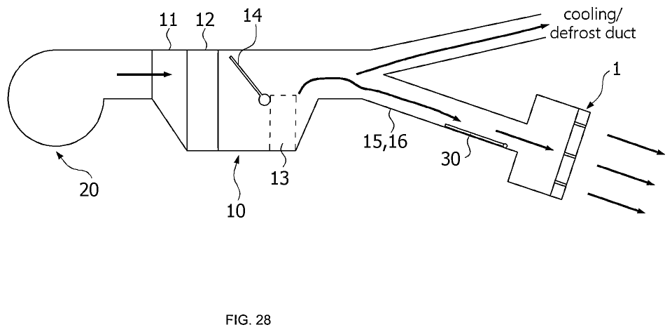

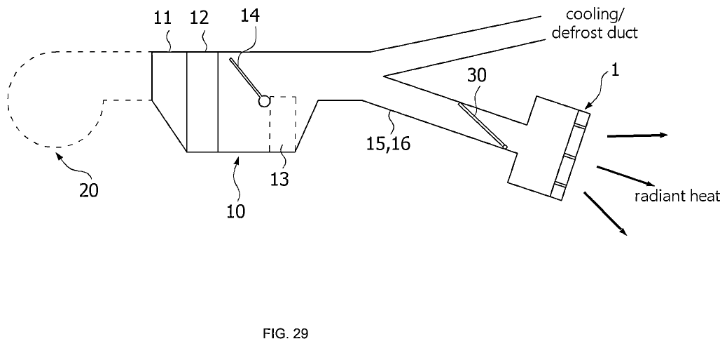

FIGS. 27 to 29 are diagrams illustrating the operation control of a vehicle heating device according to an embodiment: FIG. 27 illustrating the maximum heating mode of a vehicle heating device according to an embodiment, FIG. 28 illustrating the mild heating mode of a vehicle heating device according to an embodiment, and FIG. 29 illustrating the radiation mode of a vehicle heating device according to an embodiment.

With reference to FIG. 27, the heater 13 of the air conditioning unit 10, the blower unit 20, and the heating module 100 of the vehicle heating device 1 are in the ON state, allowing the air supplied by the blower unit 20 to be heated. In this case, the door 30 placed in the floor duct 15 is in the open position. Here, the ON state may indicate that power is supplied to each component to operate. The heater 13 of the air conditioning unit 10, the blower unit 20, the door 30, and heating module 100 of the vehicle heating device 1 may be controlled by the control unit.

For instance, the air supplied into the air conditioning unit 10 by the blower unit 20 is first heated by the heater 13 and then further heated by the vehicle heating device 1 before being discharged into the vehicle's interior. Consequently, in the maximum heating mode of the vehicle heating device 1, the vehicle's interior may be heated to the maximum extent. The operating conditions for this maximum heating mode may be satisfied when the outside temperature is below minus 20 degrees Celsius or until the vehicle interior temperature reaches 15 degrees Celsius.

With reference to FIG. 28, the blower unit 20 and the heating module 100 of the vehicle heating device 1 are in the ON state, allowing the air supplied by the blower unit 20 to be heated. In this case, the heater 13 of the air conditioning unit 10 is in the OFF state, and the door 30 placed in the floor duct 15 is in the open position. Here, the OFF state may indicate that power to the components is cut off, suspending their operation.

For example, air supplied by the blower unit 20 may pass through the interior of the air conditioning unit 10 and floor duct 15 to reach the vehicle heating device 1. Then, this air may be heated in the vehicle heating device 1 and discharged into the vehicle's interior. Consequently, in the mild heating mode of the vehicle heating device 1, the vehicle's interior may be heated. The operating conditions for this mild heating mode may be satisfied when the outside temperature ranges from 5 to 10 degrees Celsius, or when the temperature inside the vehicle reaches 15 degrees Celsius after the maximum heating mode.

With reference to FIG. 29, the heating module 100 of the vehicle heating device 1 may perform heating with radiant heat while in the ON state. In the case, the heater 13 and blower unit 20 of the air conditioning unit 10 are in the OFF state, and the door 30 placed in the floor duct 15 is closed.

For example, since the blower unit 20 is not operational and the door 30 is closed, the supply of air to the vehicle heating device 1 may be blocked. Consequently, in the radiation heating mode of the vehicle heating device 1, the vehicle's interior may only be heated by the vehicle heating device 1. The operating conditions for this radiation mode may include cold starts, extreme low initial temperatures below minus 20 degrees Celsius, the vehicle's interior temperature reaching a predetermined temperature, or occupant selection.

Furthermore, in the radiation heating mode of the vehicle heating device 1, even when the temperature of the heating module 100 increases due to the interruption of air supply, the vehicle heating device 1 is capable of preventing overheating of the heating module 100 using the heating unit 200 with an overheating prevention structure.

The embodiment of the present invention has been specifically described above with reference to the accompanying drawings.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

### DESCRIPTION OF REFERENCE NUMERALS

1: Vehicle heating device, 10: Air conditioning unit, 15: Floor duct, 20: Blower unit, 30: Door, 100: Heating module, 200: Heating unit, 210: Body, 211: Hole, 220: First electrode, 230: Second electrode, 240: First heating element, 250: Second heating element, 260: Cover member, 300: Frame, 400: Housing, 500: Support member, 600: Cover, 610: Cover body, 620: Guide, 630: Guide hole, 650: Ventilation hole, 700: Sensor

1. A vehicle heating device connected to an air conditioning unit to radiate heat, the device comprising:
a housing connected to the air conditioning unit;
a heating module arranged inside the housing; and
a cover coupled to the housing, wherein the cover comprises a cover body and guides configured to direct air passing through the cover body, the guides having a predetermined separation distance from the heating module.

2. The device of claim 1, wherein the guides comprise a first guide and a second guide, the second guide being arranged at a predetermined inclination angle relative to the first guide.

3. The device of claim 2, wherein the heating module comprises:
a heating unit; and
a frame configured to support the heating unit,
wherein the heating unit comprises a planar body with a hole formed therein, a first electrode and a second electrode arranged on the body, and a heating element arranged between the first and second electrodes, and the separation distance is equal to or smaller than the shortest width (W) of the hole.

4. The device of claim 3, wherein the separation distance is formed within a range of 9.5 to 0.75 times the shortest width (W) of the hole.

5. The device of claim 3, wherein the shortest width (W) of the hole is formed to be larger than the shortest width of a guide hole formed in the cover body.

6. The device of claim 2, wherein the housing comprises an inlet formed to allow air to flow into the interior, and the second guide, which is positioned farther from the inter than the first guide, is arranged at a predetermined inclination angle relative to the first guide.

7. The device of claim 6, wherein the distance between the inner surface of the housing and the heating module decreases as the distance from the inlet increases.

8. The device of claim 6, wherein the first guide is arranged to overlap with the inlet in the vertical direction.

9. The device of claim 1, wherein the housing comprises an inlet formed to allow air to flow into the interior, and the guides have a larger inclination angle as the distance from the inlet increases.

10. The device of claim 1, wherein the cover comprises a plurality of guide holes formed to have a first width and a second with, the first width being smaller than the second width.

11. The device of claim 1, wherein the heating module is a film heater or a positive temperature coefficient (PTC) heater

12. The device of claim 1, wherein the guides comprise a first group comprising a plurality of first guides, a second group comprising a plurality of second guides, and a third group comprising a plurality of third guides, the second and third guides being arranged to have a predetermined inclination angle relative to the first guides, the inclination angle of the second guides smaller than the inclination angle of the third guides.

13. The device of claim 1, wherein the cover further comprises a ventilation hole formed on a side of the cover body.

14. The device of claim 1, wherein the housing is rotatably connected to a floor duct of the air conditioning unit.
